(19) United States
(12) Patent Application Publication
(10) Pub. No.: US 2014/0061414 A1
(43) Pub. Date: Mar. 6, 2014

(54) MOUNTING APPARATUS FOR OPTICAL DEVICE

(71) Applicant: Steven Tai, Chicago, IL (US)

(72) Inventor: Steven Tai, Chicago, IL (US)

(73) Assignee: Electro-Motive Diesel, Inc., LaGrange, IL (US)

(21) Appl. No.: 13/600,281

(22) Filed: Aug. 31, 2012

(51) Int. Cl. F16M 13/00

(52) U.S. Cl. 248/288.11

(57) ABSTRACT

A mounting apparatus for an optical device is provided. The mounting apparatus includes a bracket member, a support member, and a mounting adapter. The bracket member is configured to be connected to a surface. The support member includes a pair of ends. The first end is releasably connected to the bracket member. The mounting adapter is swiveably connected to a second end of the support member.

### TECHNICAL FIELD

The present disclosure relates to a mounting apparatus, and more particularly to a mounting apparatus for an optical device.

### BACKGROUND

Conventional mounting assemblies for optical devices such as photographic cameras and video recorders include many brackets that are connected to each other. These brackets, when connected to each other and mounted with the optical device, provide one or more degrees of freedom of movement to the optical device. However, the numerous brackets used to construct the mounting assembly may result in a bulky and complex construction. Further, the brackets involved in the mounting assembly move relative to each other thereby requiring a large space to operate. Thus, use of such mounting assemblies may be limited to a space devoid of intervening articles or objects.

U.S. Pat. No. 7,440,027 relates to a camera mounting assembly for mounting a camera to a support structure. The mounting assembly includes a first bracket, a second bracket, and a third bracket. The first bracket is fixable to the camera body. The second bracket engages the first bracket and is rotatable about a first axis. The third bracket engages the second bracket and is rotatable about a second axis. The third bracket is securable to the support structure and is rotatable about a third axis. The first, second and third axes are substantially mutually perpendicular.

### SUMMARY

In one aspect, the present disclosure provides a mounting apparatus for an optical device. The mounting apparatus includes a bracket member, a support member, and a mounting adapter. The bracket member is configured to be connected to a surface. The support member includes a pair of ends. The first end is releasably connected to the bracket member. The mounting adapter is swiveably connected to a second end of the support member.

In another aspect, the present disclosure provides a mounting apparatus for an optical device. The mounting apparatus includes a bracket member, a support member, and a mounting plate. The bracket member is configured to be connected to a surface. The support member includes a top portion releasably connected to the bracket member. The mounting plate extends from a bottom portion of the support member.

Other features and aspects of this disclosure will be apparent from the following description and the accompanying drawings.

### BRIEF DESCRIPTION OF THE DRAWINGS

FIG. 1 shows a perspective view of a mounting apparatus with a surface in accordance with an embodiment of the present disclosure;

FIG. 2 shows a top perspective view of the mounting apparatus with an exemplary optical device;

FIG. 3 shows an rear perspective view of the mounting apparatus;

FIG. 4 shows a front perspective view of the mounting apparatus in accordance with another embodiment of the present disclosure; and

FIG. 5 shows a rear perspective view of the mounting apparatus in accordance with yet another embodiment of the present disclosure.

### DETAILED DESCRIPTION

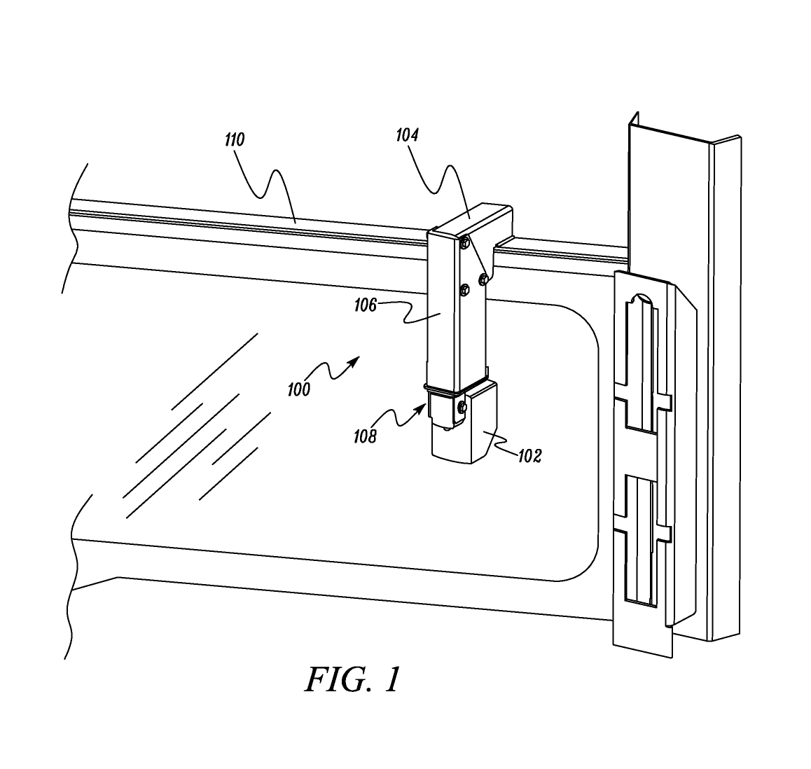

The present disclosure relates to a mounting apparatus for an optical device. FIG. 1 shows a perspective view of the mounting apparatus 100 in which disclosed embodiments may be implemented. The mounting apparatus 100 for the optical device 102 includes a bracket member 104, a support member 106, and a mounting adapter 108. The bracket member 104 is configured to be connected to a surface 110. In an embodiment as shown in FIG. 1, the bracket member 104 is configured to be rigidly connected to a cab of a vehicle. In other embodiments, the vehicle may embody a skid steer loader, a compact loader, an excavator, a locomotive such as a train or any commercial automobile such as a car. In an embodiment, the bracket member 104 is made of metal, for example, mild steel such that the bracket member 104 may be welded to a corresponding metallic surface 110. In an other embodiment, the bracket member 104 may be configured to be releasably connected to the surface 110 by at least one of bolting and riveting, as will be explained later in this disclosure.

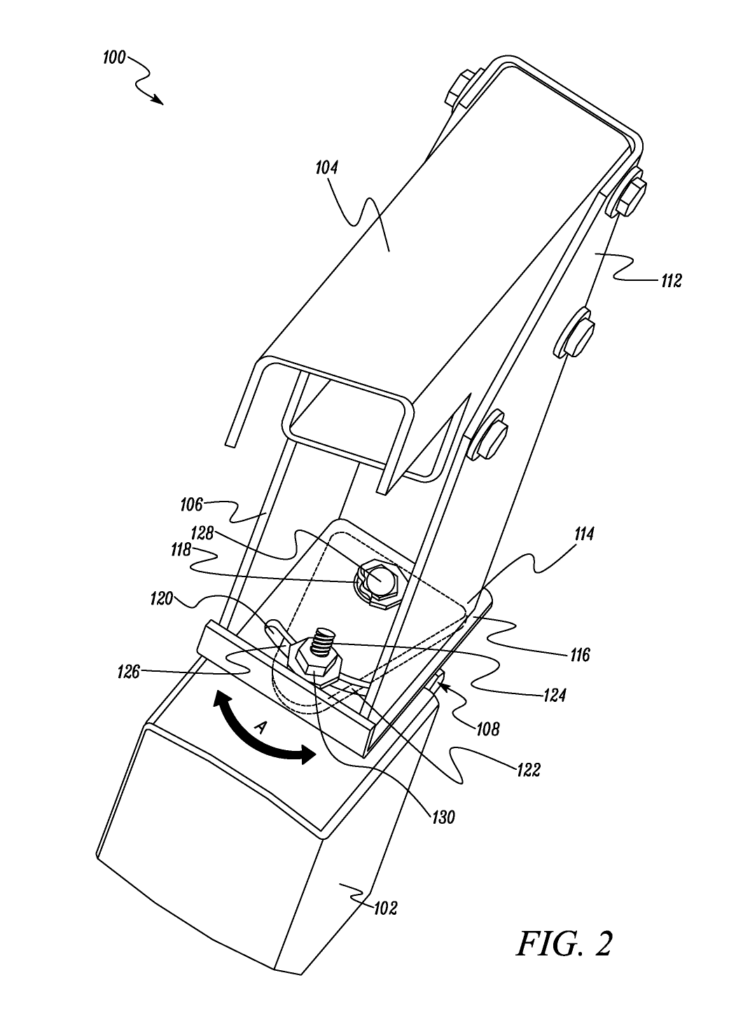

In an embodiment as shown in FIGS. 1-2, the bracket member 104 is L-shaped. Although in the preceding embodiment, it is disclosed that the bracket member 104 is L-shaped, a person of ordinary skill in the art will acknowledge that the shape of the bracket member 104 disclosed herein is exemplary in nature and does not limit the scope of this disclosure. Therefore, in view of the preceding embodiments of the vehicle, the bracket member 104 may be configured to connect to other structures of the vehicle.

As shown in FIG. 1, the support member 106 includes a pair of ends 112, 114. The first end 112 is releasably connected to the bracket member 104. The releasable connection of the support member 106 to the bracket member 104 may be accomplished by commonly known methods in the art such as bolting, providing locking tabs and the like. In the specific embodiment shown in FIG. 2, the releasable connection of the support member 106 to the bracket member 104 is shown by bolting.

As shown in FIG. 2, the mounting adapter 108 is swiveably connected to a second end 114 of the support member 106. The direction of swivel of the mounting adapter 108 with respect to the support member 106 is shown by curved arrow A. This direction of swivel A may be a panning feature for the optical devices 102 such as photographic cameras and video recorders.

In an embodiment as shown in FIG. 2, a plate 116 may be defined at the second end 114 of the support member 106. This plate 116 may include an opening 118 and an arcuate cut out 120. In this embodiment, the mounting adapter 108 may include a base 122, and a threaded pin 124 extending from a first side 126 of the base 122. In a further embodiment, the base 122 may be swiveably connected to the plate 116 at the opening 118 by a threaded fastener 128. In an other embodiment, the base 122 may be swiveably connected to the plate 116 at the arcuate cut out 120 by the threaded pin 124 and a nut 130.

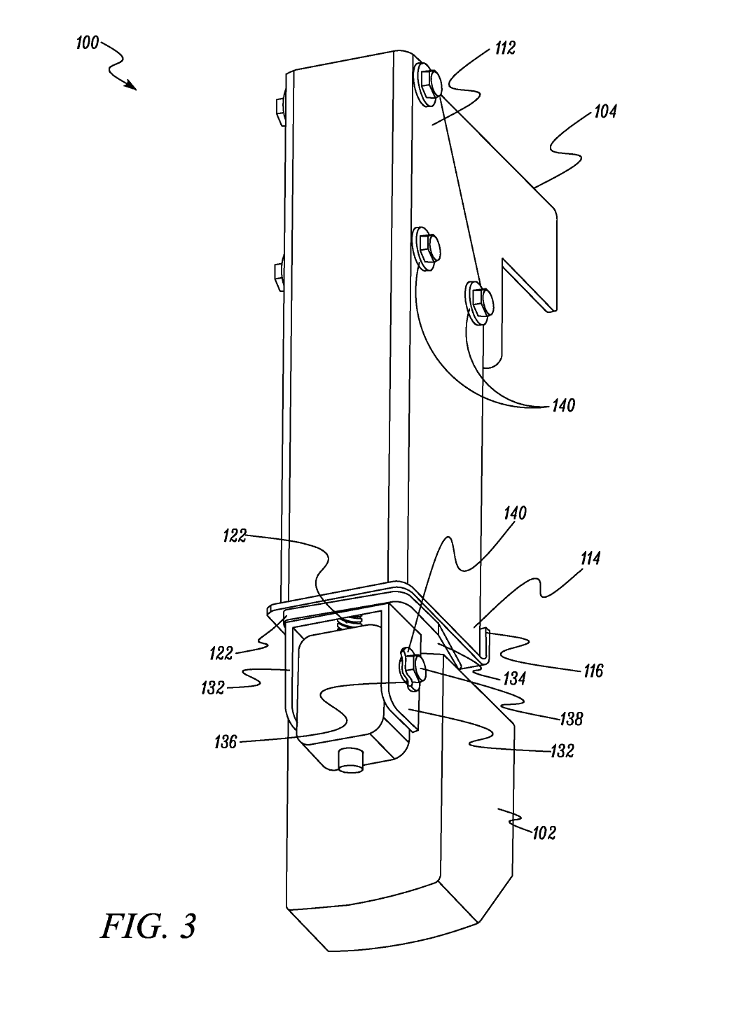

Further, as shown in FIG. 3, the mounting adapter 108 may include a pair of tabs 132 extending from a second side 134 of the base 122. Each of the tabs 132 may include a threaded opening 136. In an embodiment, the mounting apparatus 100 may further include threaded fasteners 138 at the threaded openings 136 of the tabs 132. These threaded fasteners 138 may be configured to grip the optical device 102 between the tabs 132 of the mounting adapter 108. The threaded fastener 128 swiveably connecting the base 122 to the plate 116 at the opening 118 may be a bolt. The threaded fasteners 138 configured to grip the optical device 102 between the tabs 132 may also be bolts. Therefore, it is to be understood that the threaded fasteners 128, 138 at any of the locations disclosed herein may be of similar or dissimilar configurations. Further, the threaded fasteners 128, 138 may be of any configuration commonly known in the art such as a hex-bolt, grub bolt and the like.

In an embodiment as shown in FIG. 3, the mounting apparatus 100 may further include spring washers 140 at the releasable and swiveable connections. The spring washers 140 may be configured to absorb vibrational energy imparted at the releasable and swiveable connections. Therefore, the spring washers 140 help the threaded fasteners 128, 138 to stay in position.

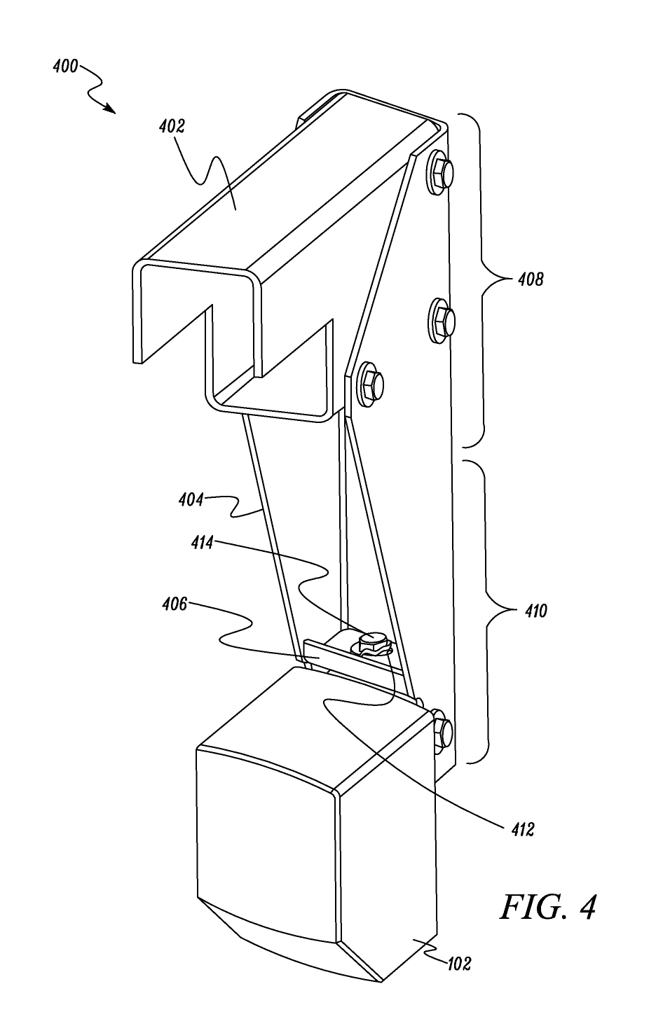

In an other embodiment of the mounting apparatus 400 shown in FIG. 4, the mounting apparatus 400 may include a bracket member 402, a support member 404 and a mounting plate 406. The support member 404 includes a top portion 408 releasably connected to the bracket member 402. The mounting plate 406 extends from a bottom portion 410 of the support member 404. In this embodiment, the mounting plate 406 includes at least one threaded opening 412. Further, the mounting apparatus 400 may include a threaded fastener 414 engaged to the threaded opening 412. The threaded fastener 414 configured to releasably connect the optical device 102 to the mounting plate 406. As disclosed earlier in the embodiments of FIGS. 2-3, the threaded fastener 414 in this embodiment may also be a bolt of any configuration commonly known in the art.

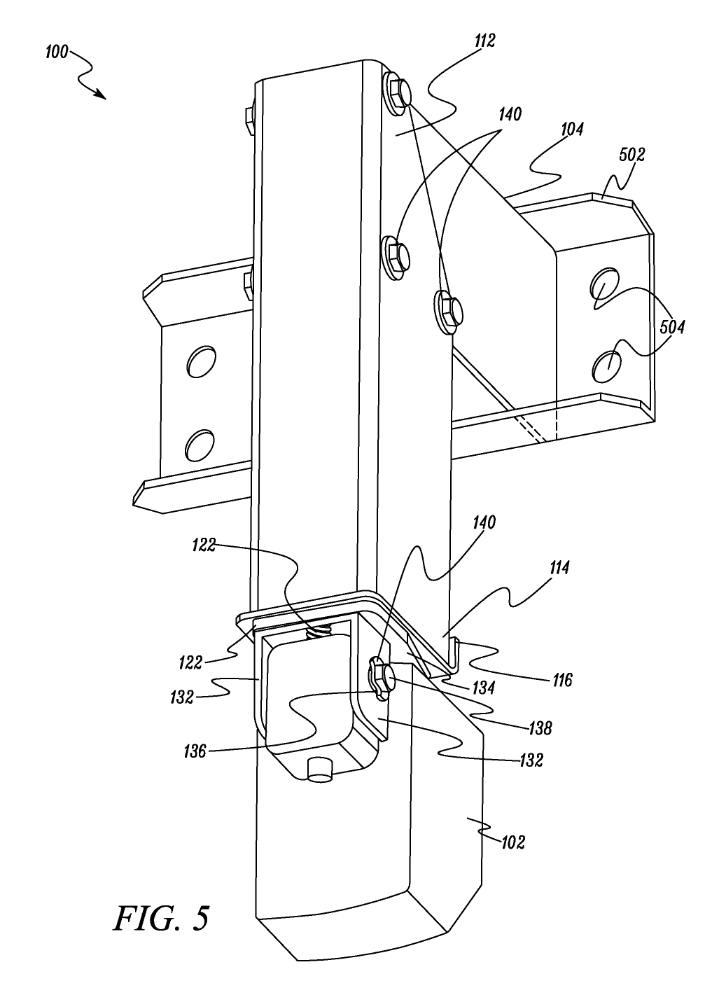

As disclosed above, in an embodiment, the bracket member 104 may be configured to be releasably connected to the surface 110 by bolting. As can be seen from FIG. 5, the bracket member 104 may include a face plate 502 with holes 504. The holes 504 of the face plate 502 may be adapted to receive bolts (not shown) therein while the face plate 502 may be adapted to clamp itself against the surface 110.

### INDUSTRIAL APPLICABILITY

Mounting assemblies for optical devices 102 are provided in vehicles to monitor the vehicle operator and other elements present in the field of view of the optical device 102. Typically, these mounting assemblies include brackets that are connected to each other. These brackets, when connected to each other and mounted with the optical device 102, provide one or more degrees of freedom of movement to the optical device 102. However, the numerous brackets used to construct the mounting assembly may result in a bulky and complex construction. Further, the brackets involved in the mounting assembly move relative to each other thereby requiring a large space to operate. Thus, use of such mounting assemblies may be limited to a space devoid of intervening articles or objects.

The mounting apparatus 100 disclosed herein is easy to assembly and operate. Firstly, the bracket member 104 of the mounting apparatus 100 may be connected to a surface 110 by welding or bolting. With regards to use of the mounting apparatus 100 in a vehicle, the mounting apparatus 100 may be welded to a cab of the vehicle or any other structure in the vehicle. The welding process may be of a type commonly known in the art such as thermal inert gas (TIG) welding, or metal inert gas (MIG) welding process. Secondly, the support member 106 may be releasably connected to the bracket member 104 by bolting. Hence, the support member 106 may be quickly disconnected from the bracket member 104 upon un-bolting of the bolts. Thirdly, the base 122 of the mounting adapter 108 may be swiveably connected to the plate 116 at the opening 118 by a threaded fastener 128, for example, a bolt. Further, the base 122 may be swiveably connected to the plate 116 at the arcuate cut out 120 by the threaded pin 124 and the nut 130. Fourthly, threaded fasteners 138 at the threaded openings 136 of the tabs 132 may be tightened to grip the optical device 102 between the tabs 132.

A user may choose to position the optical device 102 at a desired position. Once positioned, the user may fix the optical device 102 at the desired position until any adjustments are required. During operation of the mounting apparatus 100, the various components of the mounting apparatus 100 and the optical device 102 may remain static hence requiring a definite amount of space. This fixed arrangement of the mounting apparatus 100 with the optical device 102 during operation requires lesser space. Hence, the mounting apparatus 100 may be convenient to use in cramped spaces such as cabs of vehicles.

Further, a remote station may wirelessly receive data in the form of photographs or video footage from the optical device 102 that may help to monitor activities associated with the operator or the vehicle. Thus, positioning of the optical device 102 within the cab of heavy vehicles such as skid steer loaders, compact loaders, or excavators may ensure smooth operation of the machine via instructions or feedback passed on from the remote station.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A mounting apparatus for an optical device, the mounting apparatus comprising:
a bracket member configured to be connected to a surface;
a support member including a pair of ends, a first end releasably connected to the bracket member; and
a mounting adapter swiveably connected to a second end of the support member.

2. The mounting adapter of claim 1, wherein the bracket member is configured to be connected to a cab of a vehicle.

3. The mounting adapter of claim 1, wherein the bracket member is made of metal.

4. The mounting adapter of claim 3, wherein the bracket member is rigidly connected to the surface by welding.

5. The mounting adapter of claim 1, wherein the bracket member is configured to be releasably connected to the surface by at least one of bolting and riveting.

6. The mounting apparatus of claim 1, wherein the bracket member is L-shaped.

7. The mounting apparatus of claim 1, wherein a plate is defined at the second end of the support member, the plate including an opening and an arcuate cut out.

8. The mounting apparatus of claim 7, wherein the mounting adapter includes:
a base including a pair of sides;
a threaded pin extending from a first side of the base; and
a pair of tabs extending from a second side of the base, each of the tabs including a threaded opening.

9. The mounting apparatus of claim 8, wherein the base is swiveably connected to the plate at the opening by a threaded fastener.

10. The mounting apparatus of claim 8, wherein the base is swiveably connected to the plate at the arcuate cut out by the threaded pin and a nut.

11. The mounting apparatus of claim 8 further comprising threaded fasteners at the threaded openings of the tabs, the threaded fasteners configured to grip the optical device between the tabs.

12. A mounting apparatus for an optical device, the mounting apparatus comprising:
a bracket member configured to be connected to a surface;
a support member including a top portion releasably connected to the bracket member; and
a mounting plate extending from a bottom portion of the support member.

13. The mounting adapter of claim 12, wherein the bracket member is configured to be connected to a cab of a vehicle.

14. The mounting adapter of claim 12, wherein the bracket member is made of metal.

15. The mounting adapter of claim 14, wherein the bracket member is rigidly connected to the surface by welding.

16. The mounting adapter of claim 12, wherein the bracket member is configured to be releasably connected to the surface by at least one of bolting and riveting.

17. The mounting apparatus of claim 12, wherein the bracket member is L-shaped.

18. The mounting apparatus of claim 12, wherein the mounting plate includes at least one threaded opening.

19. The mounting apparatus of claim 18 further comprising a threaded fastener engaged to the threaded opening, the threaded fastener configured to releasably connect the optical device to the mounting plate.

20. A mounting apparatus for an optical device, the mounting apparatus comprising:
a metallic bracket member configured to be connected to a surface;
a support member including a first end releasably connected to the metallic bracket member;
a plate defined at the second end of the support member, the plate including an opening and an arcuate cut out; and
a mounting adapter including:
a base swiveably connected to the plate at the opening by a threaded fastener, the base including a pair of sides;
a threaded pin extending from a first side of the base; and
a pair of tabs extending from a second side of the base, each of the tabs including a threaded opening.
